(19) United States
(12) Patent Application Publication
(10) Pub. No.: US 2016/0086550 A1
(43) Pub. Date: Mar. 24, 2016

(54) DISPLAY APPARATUS AND A METHOD OF DRIVING THE SAME

(71) Applicant: SAMSUNG DISPLAY CO., LTD., YONGIN-SI (KR)

(72) Inventors: SEUNG-WOON SHIN, ASAN-SI (KR); JAE-KOOK KIM, ASAN-SI (KR); JeongJin PARK, CHEONAN-SI (KR); CHOONGSEOB OH, YONGIN-SI (KR); HYOUNGBIN LIM, ASAN-SI (KR); YONG-JU JEONG, SEOUL (KR); MINSUNG CHOI, CHEONAN-SI (KR)

(21) Appl. No.: 14/848,696

(22) Filed: Sep. 9, 2015

(30) Foreign Application Priority Data
Sep. 18, 2014 (KR) 10-2014-0124266

(51) Int. Cl. G09G 3/34; G09G 3/20; H05B 33/08

(52) U.S. Cl. CPC G09G 3/3413; H05B 33/0842; G09G 3/2096; G09G 3/2003

(57) ABSTRACT

A display apparatus includes a display panel, a panel driver, a light source part, and a light source driver. The display panel includes a first sub-pixel having a first primary color, a second sub-pixel having a second primary color, and a third sub-pixel having a white color. The panel driver drives the first, second, and third sub-pixels. The light source part provides the display panel with light. The light source part includes a first light source and a second light source. The first light source emits the light having a mixed color of the first primary color and the second primary color. The second light source emits the light having a third primary color. The first and second light sources are alternately turn on in one frame period. A turn-on order of the first and second light sources is changed by a unit of at least one frame period.

### CROSS-REFERENCE TO RELATED APPLICATION

This U.S. non-provisional patent application claims priority under 35 U.S.C. §119 to Korean Patent Application No. 10-2014-0124266, filed on Sep. 18, 2014, in the Korean Intellectual Property Office (KIPO), the disclosure of which is incorporated by reference herein in its entirety.

### TECHNICAL FIELD

The present inventive concept relates to a display apparatus and a method of driving the display apparatus, and more particularly to, a display apparatus having increased transmittance and display quality and a method of driving the display apparatus.

### DISCUSSION OF THE RELATED ART

A liquid crystal display may realize a full color image using a space-division scheme or a time-division scheme (e.g., a field sequential scheme). In the space-division scheme, a liquid crystal display panel of the liquid crystal display includes red, green, and blue color filters which are repeatedly arranged to correspond to sub-pixels in a one-to-one correspondence.

The time-division scheme may realize the full color image with high transmittance and low manufacturing cost. In the time division scheme, the color filters may be omitted from the liquid crystal display panel, and a backlight unit disposed at a rear side of the liquid crystal display panel may include a red light source, a green light source, and a blue light source which emit a red color, a green color, and a blue color, respectively. Thus, red, green, and blue color images may be sequentially displayed, and thus, a viewer may perceive the full color image obtained by combining the red, green, and blue color images.

In the liquid crystal display to which the time-division scheme is applied, the red, green and blue color images may be separately perceived when a viewpoint is changed due to a blinking of eyes or a movement of the viewer (e.g., referred to as a “color breakup phenomenon”).

### SUMMARY

According to an exemplary embodiment of the present inventive concept, a display apparatus is provided. The display apparatus includes a display panel, a panel driver, a light source part, and a light source driver. The display panel includes a first sub-pixel having a first primary color, a second sub-pixel having a second primary color, and a third sub-pixel having a white color. The panel driver drives the first, second, and third sub-pixels. The light source part provides the display panel with light. The light source part includes a first light source and a second light source. The first light source emits the light having a mixed color of the first primary color and the second primary color. The second light source emits the light having a third primary color. The light source driver drives the first and second light sources to alternately turn on the first and second light sources during a first frame period and a second frame period of a plurality of frame periods. The first and second light sources are turned on with a first turn-on order during the first frame period, and the first and second light sources are turned on with a second turn-order different from the first turn-on order during the second frame period.

A change between the first turn-on order and the second turn-on order of the first and second light sources may occur by a unit of at least one frame.

The first frame period may include a first sub-frame period and a second sub-frame period subsequent to the first sub-frame period. The first light source may be turned on during one of the first sub-frame period and the second sub-frame period, and the second light source may be turned on during another one of the first sub-frame period and the second sub-frame period. The fourth sub-frame period may be subsequent to the third sub-frame period.

The first light source may be turned on during the first sub-frame period of the first frame period, the second light source may be turned on during the second sub-frame period of the first frame period, the second light source may be turned on during a third sub-frame period of the second frame period, and the first light source may be turned on during a fourth sub-frame period of the second frame period.

The panel driver may be operated in synchronization with the light source driver.

When the display panel displays an image at a first frequency, the light source driver may alternately turn on the first and second light sources at the first frequency.

When the display panel displays a three-dimensional (3D) image at a first frequency, the light source driver may alternately turn on the first and second light sources at a second frequency twice the first frequency.

The first frequency may be substantially 120 Hz, and the second frequency may be substantially 240 Hz.

The mixed color may be a yellow color and the third primary color may be a blue color.

According to an exemplary embodiment of the present inventive concept, a method of driving a display apparatus is provided. The method includes driving a display panel using a panel driver, turning on a first light source emitting light having a mixed color of a first primary color and a second primary color, and turning on a second light source emitting light having a third primary color. The display panel includes a first sub-pixel having the first primary color, a second sub-pixel having the second primary color, and a third sub-pixel having a white color. The first and second light sources are alternatively turned on with a first turn-on order during a first frame period of a plurality of frame periods, and the first and second light sources are alternatively turned on with a second turn-on order different from the first turn-on order during a second frame period of the plurality of frame periods.

According to an exemplary embodiment of the present inventive concept, a display apparatus is provided. The display apparatus includes a display panel, a light source part, and a light source driver. The display panel includes a first sub-pixel having a first primary color, a second sub-pixel having a second primary color, and a third sub-pixel having a white color. The light source part provides the display panel with light. The light source part includes a first light source and a second light source. The first and second light sources emit light having different colors from each other. The light source driver drives the first and second light sources to turn on the first and second light sources in different orders from each other during a first frame period and a second frame period of a plurality of frame periods.

### BRIEF DESCRIPTION OF THE DRAWINGS

Exemplary embodiments of the present inventive concept will become more clearly understood from the following detailed description taken in conjunction with the accompanying drawings, in which:

FIG. 1 is a block diagram showing a display apparatus according to an exemplary embodiment of the present inventive concept;

FIG. 2 is a cross-sectional view showing the display apparatus shown in FIG. 1 according to an exemplary embodiment of the present inventive concept;

FIGS. 3A and 3B are views showing a realization of a full color image using time and space division schemes according to an exemplary embodiment of the present inventive concept;

FIG. 4 is a plan view showing a light source part shown in FIG. 1 according to an exemplary embodiment of the present inventive concept;

FIG. 5 is a view showing a turn-on time point of each block as a function of a time lapse according to an exemplary embodiment of the present inventive concept;

FIG. 6 is a view showing a movement of a white box in a display apparatus according to an exemplary embodiment of the present inventive concept;

FIG. 7A is a view showing a color breakup phenomenon when a display apparatus is operated at a frequency of substantially 120 Hz;

FIG. 7B is a view showing a driving method of a display apparatus according to an exemplary embodiment of the present inventive concept;

FIG. 8A is a view showing a color breakup phenomenon when a display apparatus is operated at a frequency of substantially 240 Hz; and

FIG. 8B is a view showing a driving method of a display apparatus according to an exemplary embodiment of the present inventive concept.

### DETAILED DESCRIPTION OF THE EMBODIMENTS

It will be understood that when an element or layer is referred to as being “on”, “connected to” or “coupled to” another element or layer, it can be directly on, connected or coupled to the other element or layer or intervening elements or layers may be present. Like numbers may refer to like elements throughout the specification and drawings. As used herein, the singular forms, “a”, “an” and “the” are intended to include the plural forms as well, unless the context clearly indicates otherwise.

Hereinafter, exemplary embodiments of the present inventive concept will be described in more detail with reference to the accompanying drawings.

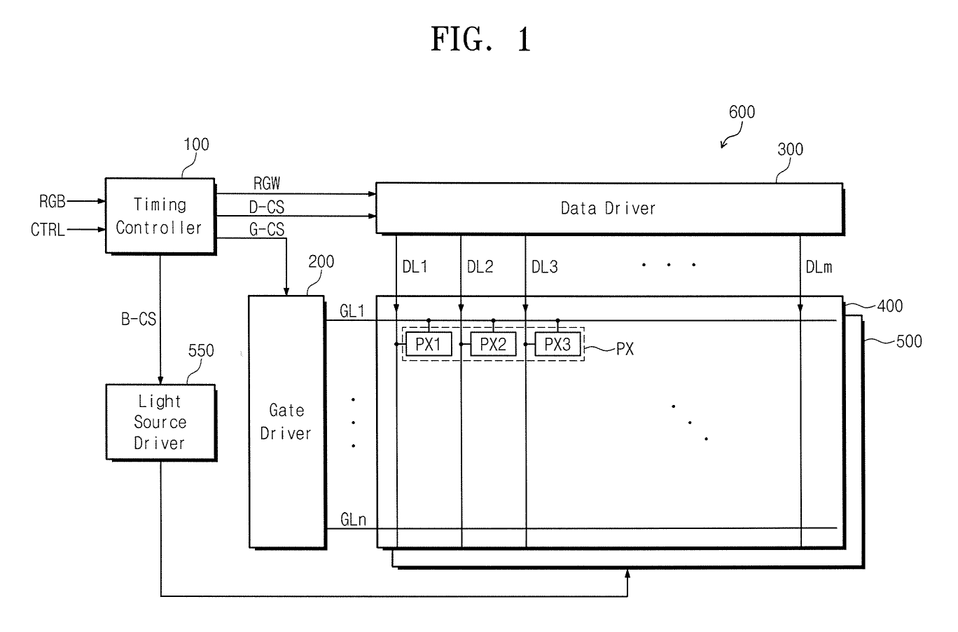

FIG. 1 is a block diagram showing a display apparatus according to an exemplary embodiment of the present inventive concept.

Referring to FIG. 1, a display apparatus 600 includes a display panel 100 for displaying an image, a panel driving part for driving the display panel 100, a light source part 500 for providing light to the display panel 100, and a light source driver 550 for driving the light source part 500. For example, the panel driving part includes a gate driver 200, a data driver 300, and a timing controller 400 for controlling operations of the gate and data drivers 200 and 300.

The display panel 100 includes a plurality of gate lines GL1 to GLn, a plurality of data lines DL1 to DLm, and a plurality of pixels PX. The gate lines GL1 to GLn extend in a row direction and are arranged in a column direction to be substantially parallel to each other. The data lines DL1 to DLm extend in the column direction and are arranged in the row direction to be substantially parallel to each other.

Each pixel PX includes first, second, and third sub-pixels PX1, PX2, and PX3 each including a thin film transistor and a liquid crystal capacitor.

The timing controller 400 receives red, green and blue image signals RGB and control signals CS from the outside of the display apparatus 600. The timing controller 400 renders the red, green and blue image signals RGB to generate red, green and white image signals RGW by taking an interface between the data driver 300 and the timing controller 400 into consideration and applies the rendered red, green and white image signals RGW to the data driver 300. In addition, the timing controller 400 generates a data control signal D-CS (e.g., an output start signal, a horizontal start signal, etc.), and a gate control signal G-CS, (e.g., a vertical start signal, a vertical clock signal), a vertical clock bar signal, etc., on the basis of the control signals CS. The data control signal D-CS is applied to the data driver 300 and the gate control signal G-CS is applied to the gate driver 200.

The gate driver 200 sequentially outputs gate signals in response to the gate control signal G-CS provided from the timing controller 400. Accordingly, the pixels PX are sequentially scanned by the gate signals in a unit of row.

The data driver 300 converts the red, green and white image signals RGW to data voltages in response to the data control signal D-CS. The data voltages are applied to the display panel 100.

Thus, each pixel PX is turned on in response to the gate signal, and the turned-on pixel PX displays the image having a desired gray scale using a corresponding data voltage of the data voltages provided from the data driver 300.

As shown in FIG. 1, the light source part 500 is disposed at a rear side of the display panel 100 and provides the light to the display panel 100 at the rear side of the display panel 100.

For example, the light source part 500 may include a plurality of light emitting diodes as a light source. In this case, the light emitting diodes may be disposed on a printed circuit board (PCB) in a stripe form or a matrix form.

The light source driver 550 receives a light source control signal B-CS from the timing controller 100 and drives the light source part 500 in synchronization with the display panel 100.

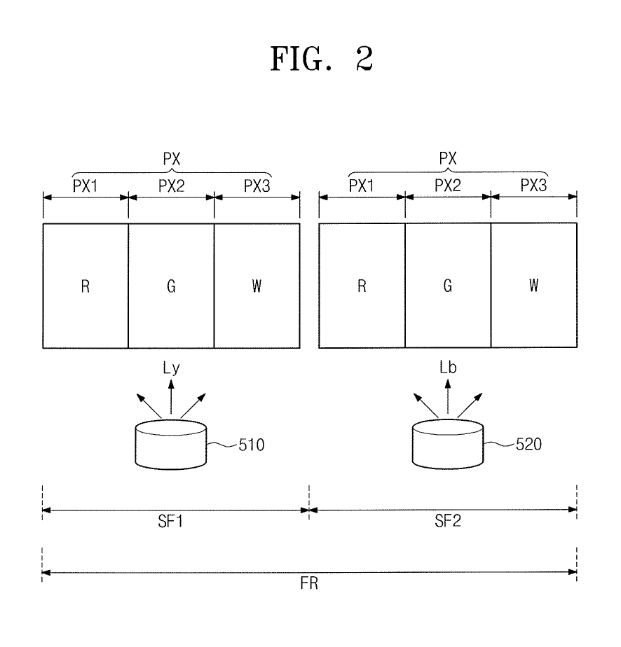

FIG. 2 is a cross-sectional view showing the display apparatus shown in FIG. 1 according to an exemplary embodiment of the present inventive concept.

Referring to FIG. 2, each pixel PX of the display panel 100 includes a first sub-pixel PX1 having a first primary color, a second sub-pixel PX2 having a second primary color, and a third sub-pixel PX3 having a white color.

In the present exemplary embodiment, the first primary color may be a red color and the first sub-pixel PX1 may include a red color filter R. The second primary color may be a green color and the second sub-pixel PX2 may include a green color filter G. The third sub-pixel PX3 may include a white color filter. In an exemplary embodiment of the present inventive concept, the third sub-pixel PX3 may not include a color filter.

In the present exemplary embodiment, the light source part 500 includes a first light source 510 and a second light source 520. The light source part 500 generates the light and provides the display panel 100 with the light. The first light source 510 generates light having a mixed color of the first primary color and the second primary color. Since the first and second primary colors are the red and green colors, respectively, the mixed color may be a yellow color.

The second light source 520 generates light having the third primary color. The third primary color may be a blue color. When the first, second, third primary colors are mixed with each other, the white color may be displayed. In the present exemplary embodiment, the first, second, and third primary colors are the red, green, and blue colors, respectively, but the present inventive concept is not limited thereto.

In the present exemplary embodiment, the first light source 510 may be, but not limited to, a light emitting diode (LED) chip emitting yellow light Ly. The second light source 520 may be, but not limited to, an LED chip emitting blue light Lb. In an exemplary embodiment of the present inventive concept, the first and second light sources 510 and 520 may be included in a single package.

The light source part 500 may have an edge illumination structure in which the first and second light sources 510 and 520 are disposed adjacent to a side surface of a light guide plate. In an exemplary embodiment of the present inventive concept, the light source part 500 may have a direct illumination structure in which a plurality of light sources is disposed under the display panel 100.

The light source driver 550, as shown in FIG. 1, drives the light source part 500. The light source driver 550 alternately turns on the first light source 510 and the second light source 520 in one frame period (FR). When the display panel 100 displays the image at a frequency of substantially 120 Hz, the light source driver 550 may alternately turn on the first and second light sources 510 and 520 at a frequency of substantially 120 Hz.

For example, when the display panel 100 displays a three-dimensional (3D) image, the display panel 100 alternately displays a left-eye image and a right-eye image. In this case, the display panel 100 may be operated at a frequency of substantially 240 Hz to display two pairs of the left-eye images and right-eye images. The light source driver 550 may alternately turn on the first and second light sources 510 and 520 at the frequency of substantially 240 Hz.

The one frame period FR includes a first sub-frame period and a second sub-frame period SF1 and SF2, and the first and second light sources 510 and 520 are turned on during different sub-frame periods from each other of the first and second sub-frame periods SF1 and SF2. For example, during the first sub-frame period SF1, the first light source 510 is turned on and the second light source 520 is turned off. During the second sub-frame period SF2, the first light source 510 is turned off and the second light source 520 is turned on.

In addition, an order in which the first and second light sources 510 and 520 are turned on (e.g., which may be referred to as “a turn-on order of the first and second light sources 510 and 520”) may be changed in a unit of at least one frame period FR. This will be described in more detail with reference to FIG. 5.

A time interval of the first sub-frame period SF1 may be substantially the same as that of the second sub-frame period SF2, but the present inventive concept is not limited thereto. For example, the time interval of the first sub-frame period SF1 may be different from that of the second sub-frame period SF2.

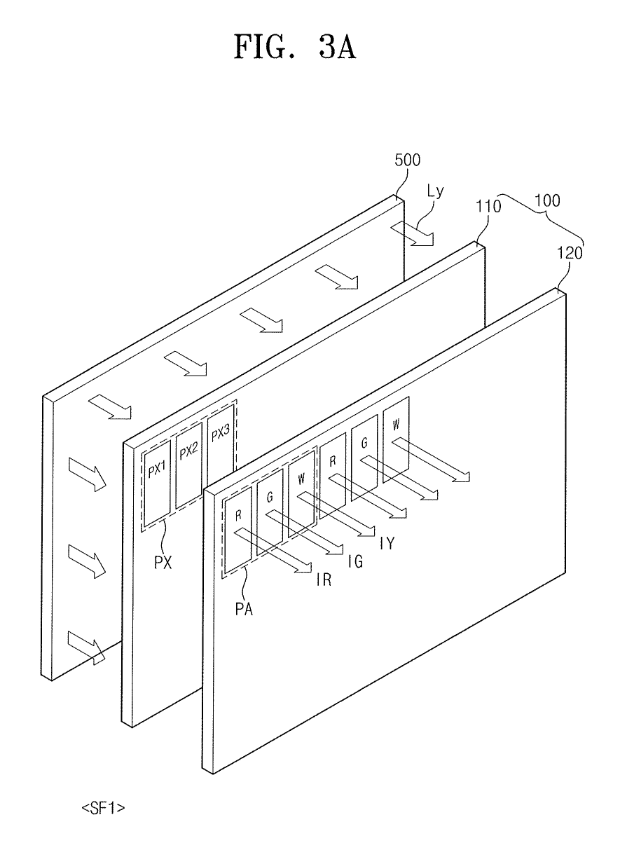

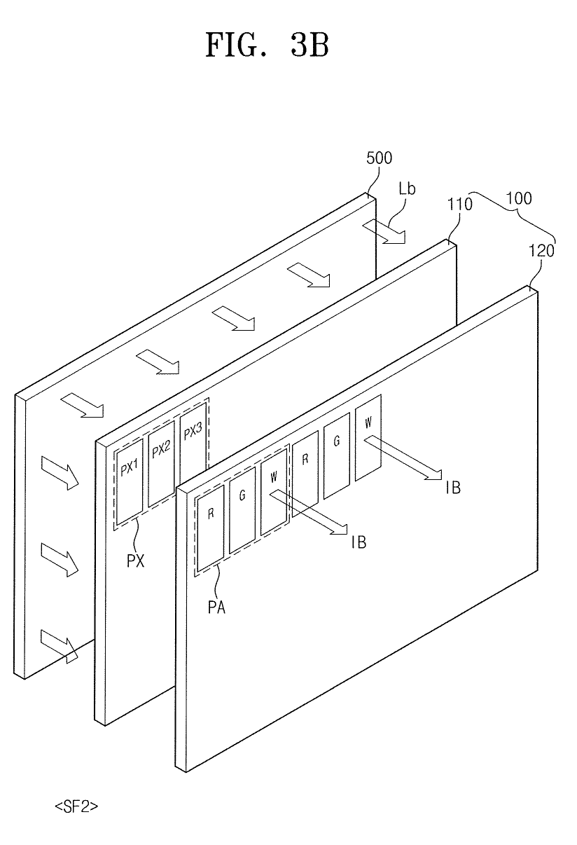

FIGS. 3A and 3B are views showing a realization of a full color image using a time-division scheme and a space-division scheme according to an exemplary embodiment of the present inventive concept. FIG. 3A shows an operation mode of the first sub-frame period SF1 of the one frame period, and FIG. 3B shows an operation mode of the second sub-frame period SF2 of the one frame period.

Referring to FIG. 3A, the display panel 100 includes a first substrate 110, a second substrate 120 substantially parallel to the first substrate 110, and a liquid crystal layer 125 interposed between the first substrate 110 and the second substrate 120.

The first substrate 110 may be a lower substrate on which the first to third sub-pixels PX1 to PX3 are disposed. The second substrate 120 may be an upper substrate on which at least two color filters R and G are disposed in each pixel area PA which corresponds to each pixel PX.

The color filters R and G may be disposed on one of the first and second substrates 110 and 120.

During the first sub-frame period SF1, the first light source 510 of FIG. 2 is turned on and the second light source 520 of FIG. 2 is turned off. Accordingly, during the first sub-frame period SF1, a red light component of yellow light Ly generated by the first light source 510 passes through the first sub-pixel PX1 and the red color filter R and is displayed as a red image IR, and a green light component of the yellow light Ly generated by the first light source 510 passes through the second sub-pixel PX2 and the green color filter G and is displayed as a green image IG. In addition, the yellow light Ly passes through the third sub-pixel PX3 and is displayed as a yellow image IY. Therefore, a first image IM1 obtained by the red image IR, the green image IG, and the yellow image IY is displayed in the first sub-frame period SF1.

Referring to FIG. 3B, the second light source 520 is turned on during the second sub-frame period SF2 and the first light source 510 is turned off during the second sub-frame period SF2. Thus, blue light Lb generated by the second light source 520 passes through the third sub-pixel PX3 and is displayed as a blue image IB during the second sub-frame period SF2. Since the blue light Lb does not pass through the first and second sub-pixels PX1 and PX2, no image is displayed in the first and second sub-pixels PX1 and PX2 during the second sub-frame period SF2. Accordingly, a second image IM2 obtained by the blue image IB is displayed in the second sub-frame period SF2.

Therefore, a viewer may recognize a normal image obtained by mixing the first and second images IM1 and IM2 when the one frame period is finished.

For example, the blue light Lb and the yellow light Ly have different intensities from each other, and the intensity of the blue light Lb may be stronger than the intensity of the yellow light Ly.

According to an exemplary embodiment of the present inventive concept, as described above, a blue color filter may not be required. Accordingly, loss of light, which is caused by the color filters, may be reduced, and thus, a light use efficiency of the display apparatus 600 may be increased.

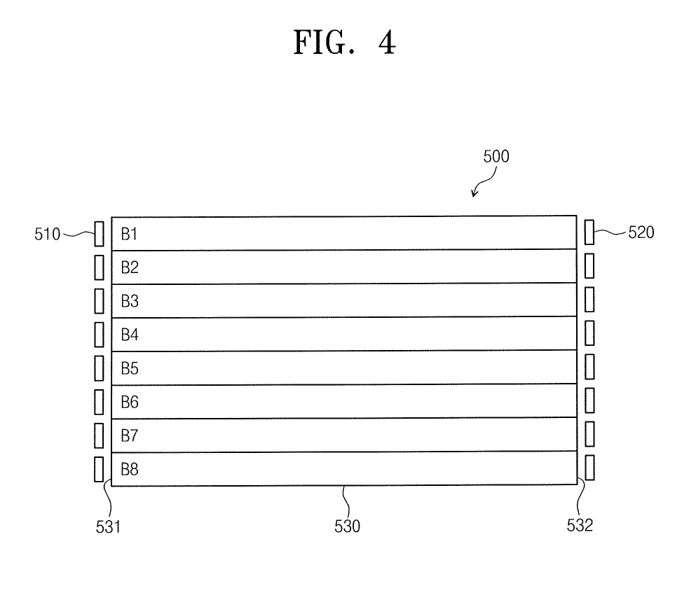

FIG. 4 is a plan view showing a light source part 500 shown in FIG. 1 according to an exemplary embodiment of the present inventive concept, and FIG. 5 is a view showing a turn-on time point of each block as a function of a time lapse according to an exemplary embodiment of the present inventive concept.

Referring to FIG. 4, the light source part 500 may have an edge illumination structure. The light source part 500 includes a light guide plate 530, the first light source 510 disposed adjacent to a first side surface 531 of the light guide plate 530, and the second light source 520 disposed adjacent to a second side surface 532 of the light guide plate 530. The light guide plate 530 has a substantially quadrangular plate shape, and the first and second side surfaces 531 and 532 correspond to two side surfaces facing each other, respectively, among four side surfaces of the light guide plate 530.

The first light source 510 includes a plurality of yellow LEDs arranged along the first side surface 531 and the second light source 520 includes a plurality of blue LEDs arranged along the second side surface 532. The yellow LEDs may be independently operated from each other and the blue LEDs may be independently operated from each other.

The yellow LEDs are sequentially turned on in a corresponding sub-frame period and the blue LEDs are sequentially turned on in a corresponding sub-frame period.

The light guide plate 530 includes a plurality of light emitting blocks B1 to B8. The light emitting blocks B1 to B8 are arranged in substantially the same direction as a direction in which the yellow and blue LEDs are arranged. Each of the yellow LEDs and each of the blue LEDs correspond to each of the light emitting blocks B1 to B8, and the yellow light and the blue light are alternately provided to each of the light emitting blocks B1 to B8 every sub-frame period. However, the number of the light emitting blocks B1 to B8 should not be limited to eight.

As shown in FIG. 5, each of successive frame periods includes a first sub-frame period and a second sub-frame period SF1 and SF2. The first light source 510 is turned on during the first sub-frame period SF1 of an n-th frame period FRn among the successive frames (n is a natural number equal to or greater than 1). The second light source 520 is turned on during the second sub-frame period SF2 of the n-th sub-frame period FRn.

During the first sub-frame period SF1 of the n-th frame period FRn, the light emitting blocks B1 to B8 sequentially emit the yellow light Ly and a light emission period of each of the light emitting blocks B1 to B8 is partially overlapped with a light emission period of a light emitting block adjacent thereto. During the second sub-frame period SF1 of the n-th frame period FRn, the light emitting blocks B1 to B8 sequentially emit the blue light Lb and a light emission period of each of the light emitting blocks B1 to B8 is partially overlapped with a light emission period of a light emitting block adjacent thereto.

The second light source 520 is turned on during the first sub-frame period SF1 of an (n+1)th frame period FRn+1 among a plurality of frames periods. The first light source 510 is turned on during the second sub-frame SF2 of the (n+1)th frame period FRn+1.

Accordingly, the light emitting blocks B1 to B8 sequentially emit the blue light Lb during the first sub-frame period SF1 of the (n+1)th frame period FRn+1 and the light emitting blocks B1 to B8 sequentially emit the yellow light Ly during the second sub-frame period SF2 of the (n+1)th frame period FRn+1.

As described above, when a turn-on order of the first and second light sources 510 and 520 is changed by a unit of frame period, a frequency with which a color mixture between the yellow light Ly and the blue light Lb occurs may be reduced by, e.g., half, during a boundary period between the first and second sub-frame periods SF1 and SF2.

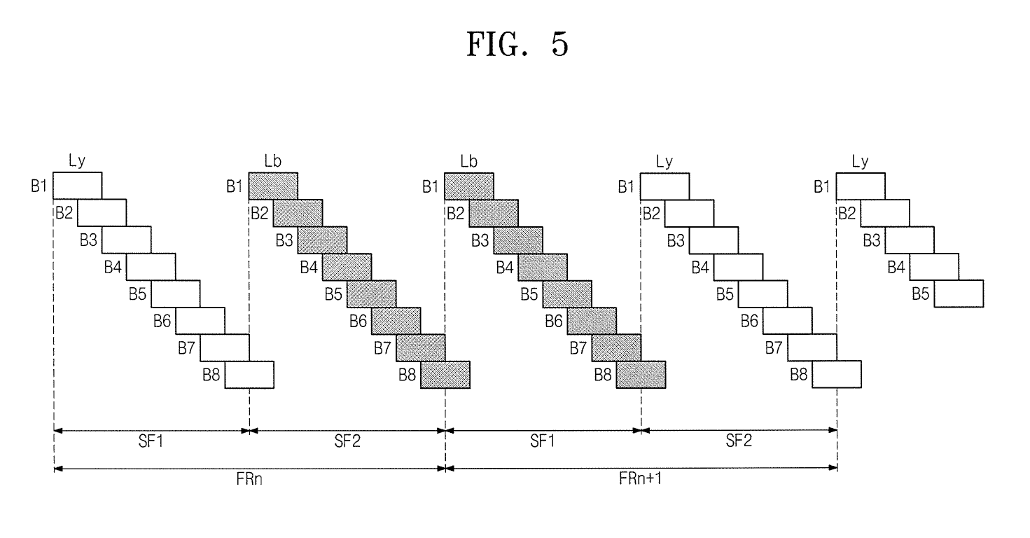

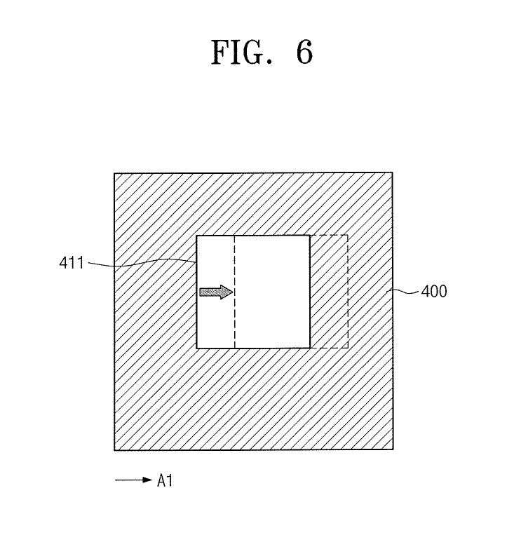

FIG. 6 is a view showing a movement of a white box 411 in a display apparatus according to an exemplary embodiment of the present inventive concept.

Referring to FIG. 6, a color breakup phenomenon indicates a phenomenon in which different colors from each other are viewed subject to color separation depending on time since the different colors are sequentially turned on at a regular interval in the display apparatus operated in a field sequential driving scheme.

For example, the same color is repeatedly displayed at a regular interval every frame period, and thus, the color break-up phenomenon is intensified when a moving image, such as a subtitle, or the like, is displayed or a display apparatus is shaken.

As shown in FIG. 6, when the white box 411 displayed on a screen of the display panel 400 moves in a direction A1, a color break pattern occurs at an edge of the white box 411.

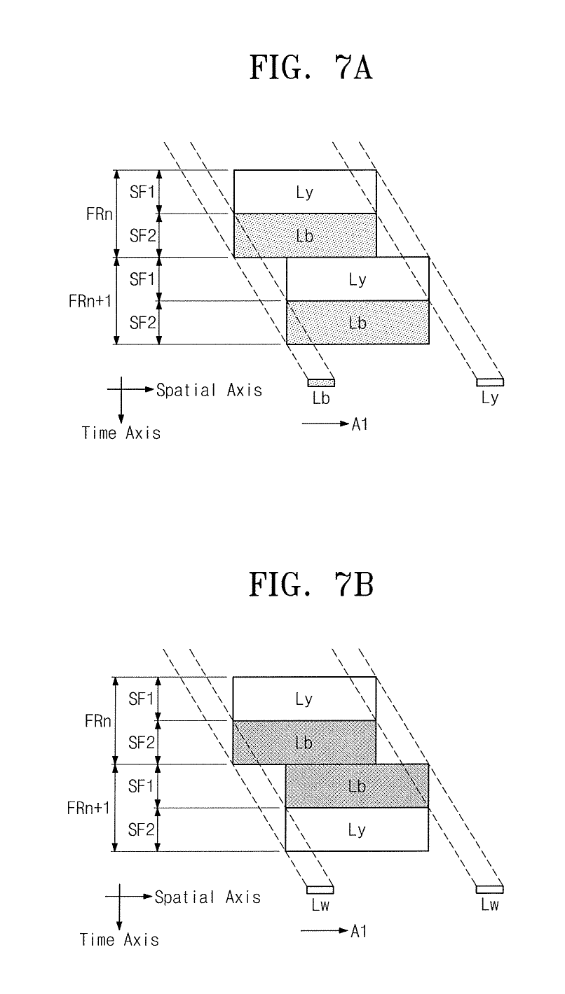

FIG. 7A is a view showing a color breakup phenomenon when a display apparatus is operated at a frequency of substantially 120 Hz, and FIG. 7B is a view showing a driving method of a display apparatus according to an exemplary embodiment of the present inventive concept.

Referring to FIG. 7A, the display apparatus 600 sequentially displays the yellow image and the blue image to display the white image in the white box 411 shown in FIG. 6. In addition, the first and second light sources 510 and 520 are turned on during different sub-frame periods from each other in the one frame period. For example, the first light source 510 is turned on during the first sub-frame period SF1 of the n-th frame period FRn and the second light source 520 is turned on during the second sub-frame period SF2 of the n-th frame period FRn. In addition, the first light source 510 is turned on during the first sub-frame period SF1 of the (n+1)th frame period FRn+1 and the second light source 520 is turned on during the second sub-frame period SF2 of the (n+1)th frame period FRn+1.

In this case, when the white box 411 moves in a predetermined direction A1, the color break pattern occurs at the edge of the white box 411. For example, since the yellow light Ly and the blue light Lb are not mixed with each other at a left lower edge of the white box 411, the white light is not perceived by a viewer and the blue light Lb is perceived by the viewer after being separated from the yellow light Ly at the left lower edge of white box 411. In addition, since the yellow light Ly and the blue light Lb are not mixed with each other at a right upper edge of the white box 411, the white light is not perceived by the viewer and the yellow light Ly is perceived by the viewer after being separated from the blue light Lb at the right upper edge of white box 411.

Referring to FIG. 7B, the display apparatus 600 is operated at the frequency of substantially 120 Hz and sequentially displays the yellow image and the blue image once during one frame period to display the white image. For example, the one frame period includes two sub-frames SF1 and SF2 in which the yellow image and the blue image are respectively displayed. The first and second light sources 510 and 520 are alternately turned on by a unit of sub-frame period and a turn-on order of the first and second light source 510 and 520 is changed by a unit of frame period. For example, when the first light source 510 is turned on during the first sub-frame period SF1 of the n-th frame period FRn and the second light source 520 is turned on during the second sub-frame period SF2 of the n-th frame period FRn, the second light source 520 is turned on during the first sub-frame period SF1 of the (n+1)th frame period FRn+1 and the first light source 510 is turned on during the second sub-frame period SF2 of the (n+1)th frame period FRn+1.

In this case, when the white box 411 moves in the predetermined direction A1, the color break pattern does not occur at the edge of the white box 411.

For example, the yellow light Ly and the blue light Lb are mixed with each other at the left lower edge of the white box 411, and thus, the white light Lw is perceived by a viewer at the left lower edge of the white box 411. In addition, the yellow light Ly and the blue light Lb are mixed with each other at the right upper edge of the white box 411, and thus, the white light Lw is perceived by the viewer at the right upper edge of the white box 411.

As described above, when the first and second light sources 510 and 520 are turned on in an order of the first and second light sources 510 and 520 during a first frame period (e.g., FRn) of two successive frame periods and in an order of the second and first light sources 520 and 510 during a second frame period (e.g., FRn+1) following the first frame period of the two successive frame periods, the color break-up phenomenon perceived by the viewer at the edge of the moving image (e.g., the white box 411) may be reduced.

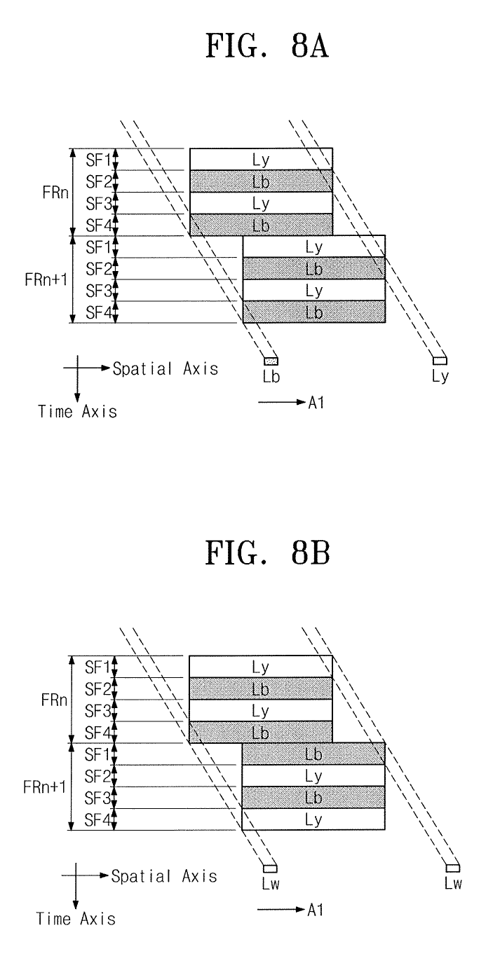

FIG. 8A is a view showing a color breakup phenomenon when a display apparatus is operated at a frequency of substantially 240 Hz, and FIG. 8B is a view showing a driving method of a display apparatus according to an exemplary embodiment of the present inventive concept.

Referring to FIG. 8A, the display apparatus 600 is operated at the frequency of substantially 240 Hz and sequentially displays the yellow image and the blue image twice during one frame period to display the white image. For example, the one frame period includes four sub-frames SF1 to SF4 in which the yellow image and the blue image are alternately displayed. The first and second light sources 510 and 520 are alternately turned on by a unit of sub-frame period. For example, when the first light source 510 is turned on during first and third sub-frame periods SF1 and SF3 of the n-th frame period FRn and the second light source 520 is turned on during second and fourth sub-frame periods SF2 and SF4 of the n-th frame period FRn, the first light source 510 is turned on during the first and third sub-frame periods SF1 and SF3 of the (n+1)th frame period FRn+1 and the second light sources 520 is turned on during the second and fourth sub-frame periods SF2 and SF4 of the (n+1)th frame period FRn+1.

In this case, when the white box 411 moves in the predetermined direction A1, a color break pattern occurs at an edge of the white box 411. For example, since the yellow light Ly and the blue light Lb are not mixed with each other at a left lower edge of the white box 411, the white light is not perceived by a viewer and the blue light Lb is perceived by the viewer after being separated from the yellow light Ly at the left lower edge of white box 411. In addition, since the yellow light Ly and the blue light Lb are not mixed with each other at a right upper edge of the white box 411, the white light is not perceived by the viewer and the yellow light Ly is perceived by the viewer after being separated from the blue light Lb at the right upper edge of white box 411.

When a frequency of the display apparatus 600 increases to, for example, substantially 240 Hz, as described with reference to FIG. 8A, an area in which a color break pattern occurs may be reduced compared with that when the display apparatus 600 is operated at the frequency of substantially 120 Hz.

Referring to FIG. 8B, the display apparatus 600 is operated at the frequency of substantially 240 Hz and sequentially displays the yellow image and the blue image twice during one frame period to display the white image. For example, the one frame period includes four sub-frames SF1 to SF4 in which the yellow image and the blue image are alternately displayed. The first and second light sources 510 and 520 are alternately turned on by a unit of sub-frame period and a turn-on order of the first and second light source 510 and 520 is changed by a unit of a frame period. For example, when the first light source 510 is turned on during the first and third sub-frames periods SF1 and SF3 of the n-th frame period FRn and the second light source 520 is turned on during the second and fourth sub-frame periods SF2 and SF4 of the n-th frame period FRn, the second light source 520 is turned on during the first and third sub-frame periods SF1 and SF3 of the (n+1)th frame period FRn+1 and the first light source 510 is turned on during the second and fourth sub-frame periods SF2 and SF4 of the (n+1)th frame period FRn+1.

In this case, when the white box 411 moves in the predetermined direction A1, the color break pattern does not occur at an edge of the white box 411.

For example, the yellow light Ly and the blue light Lb are mixed with each other at the left lower edge of the white box 411, and thus, the white light Lw is perceived by a viewer at the left lower edge of the white box 411. In addition, the yellow light Ly and the blue light Lb are mixed with each other at the right upper edge of the white box 411, and thus, the white light Lw is perceived by the viewer at the right upper edge of the white box 411.

As described above, when the first and second light sources 510 and 520 are turned on one after the other during a first frame period of two successive frame periods and the second and first light sources 520 and 510 are turned on one after the other during a second frame period following the first frame period of the two successive frame periods, a color break-up phenomenon perceived by the viewer at an edge of the moving image may be reduced.

According to an exemplary embodiment of the present inventive concept, light sources emitting different primary colors from each other may alternately be turned on in one frame period and a turn-on order of the light sources may be changed by a unit of at least one frame period. Thus, the color breakup phenomenon and color mixing phenomenon may be prevented from occurring, and thus display quality of a display apparatus may be increased.

Although the present inventive concept has been particularly described with reference to exemplary embodiments thereof, it will be understood that the present inventive concept should not be construed as limited to the disclosed exemplary embodiments thereof and various changes in forms and details may be made therein without departing from the spirit and scope of the present inventive concept, as defined in the appended claims.

What is claimed is:

1. A display apparatus comprising:
a display panel comprising a first sub-pixel having a first primary color, a second sub-pixel having a second primary color, and a third sub-pixel having a white color;
a panel driver driving the first, second, and third sub-pixels;
a light source part providing the display panel with light, the light source part comprising a first light source emitting the light having a mixed color of the first primary color and the second primary color and a second light source emitting the light having a third primary color; and
a light source driver driving the first and second light sources to alternately turn on the first and second light sources during a first frame period and a second frame period of a plurality of frame periods,
wherein the first and second light sources are turned on with a first turn-on order during the first frame period, and the first and second light sources are turned on with a second turn-order different from the first turn-on order during the second frame period.

2. The display apparatus of claim 1, wherein a change between the first turn-on order and the second turn-on order of the first and second light sources occurs by a unit of at least one frame.

3. The display apparatus of claim 1, wherein the first frame period comprises a first sub-frame period and a second sub-frame period subsequent to the first sub-frame period, and
wherein the first light source is turned on during one of the first sub-frame period and the second sub-frame period, and the second light source is turned on during another one of the first sub-frame period and the second sub-frame period.

4. The display apparatus of claim 3, wherein the first light source is turned on during the first sub-frame period of the first frame period, the second light source is turned on during the second sub-frame period of the first frame period, the second light source is turned on during a third sub-frame period of the second frame period, and the first light source is turned on during a fourth sub-frame period of the second frame period, and
wherein the fourth sub-frame period is subsequent to the third sub-frame period.

5. The display apparatus of claim 1, wherein the panel driver is operated in synchronization with the light source driver.

6. The display apparatus of claim 1, wherein when the display panel displays an image at a first frequency, the light source driver alternately turns on the first and second light sources at the first frequency.

7. The display apparatus of claim 1, wherein when the display panel displays a three-dimensional (3D) image at a first frequency, the light source driver alternately turns on the first and second light sources at a second frequency twice the first frequency.

8. The display apparatus of claim 7, wherein the first frequency is substantially 120 Hz, and the second frequency is substantially 240 Hz.

9. The display apparatus of claim 1, wherein the mixed color is a yellow color and the third primary color is a blue color.

10. A method of driving a display apparatus, comprising:
driving a display panel using a panel driver, the display panel comprising a first sub-pixel having a first primary color, a second sub-pixel having a second primary color, and a third sub-pixel having a white color;
turning on a first light source emitting light having a mixed color of the first primary color and the second primary color; and
turning on a second light source emitting light having a third primary color,
wherein the first and second light sources are alternatively turned on with a first turn-on order during a first frame period of a plurality of frame periods, and the first and second light sources are alternatively turned on with a second turn-on order different from the first turn-on order during a second frame period of the plurality of frame periods.

11. The method of claim 10, wherein the first frame period comprises a first sub-frame period and a second sub-frame period subsequent to the first sub-frame period, and
wherein the first light source is turned on during one of the first sub-frame period and the second sub-frame period, and the second light source is turned on during another one of the first sub-frame period and the second sub-frame period.

12. The method of claim 11, wherein the first light source is turned on during the first sub-frame period of the first frame period, the second light source is turned on during the second sub-frame period of the first frame period, the second light source is turned on during a third sub-frame period of the second frame period, and the first light source is turned on during a fourth sub-frame period of the second frame period, and
wherein the fourth sub-frame period is subsequent to the third sub-frame period.

13. The method of claim 10, wherein the panel driver is operated in synchronization with a light source driver driving the first and second light sources.

14. The method of claim 10, wherein when the display panel displays an image at a first frequency, the light source driver alternately turns on the first and second light sources at the first frequency.

15. The method of claim 10, wherein when the display panel displays a three-dimensional (3D) image at a first frequency, the light source driver alternately turns on the first and second light sources at a second frequency twice the first frequency.

16. The method of claim 15, wherein the first frequency is substantially 120 Hz, and the second frequency is substantially 240 Hz.

17. The method of claim 10, wherein the mixed color is a yellow color and the third primary color is a blue color.

18. A display apparatus comprising:
a display panel comprising a first sub-pixel having a first primary color, a second sub-pixel having a second primary color, and a third sub-pixel having a white color;
a light source part providing the display panel with light, the light source part comprising a first light source and a second light source emitting the light having different colors from each other; and
a light source driver driving the first and second light sources to turn on the first and second light sources in different orders from each other during a first frame period and a second frame period of a plurality of frame periods.

19. The apparatus of claim 18, wherein when the display panel displays a three-dimensional (3D) image at a first frequency, the light source driver alternately turns on the first and second light sources at a second frequency twice the first frequency.

20. The apparatus of claim 19, wherein the first frequency is substantially 120 Hz, and the second frequency is substantially 240 Hz.
